(19) United States
(12) Patent Application Publication
(10) Pub. No.: US 2022/0069329 A1
(43) Pub. Date: Mar. 3, 2022

(54) STACK ASSEMBLY MACHINE AND PROCESS

(71) Applicant: HYZON MOTORS INC., Honeoye Falls, NY (US)

(72) Inventors: Zhijun Gu, Zhangjiagang City (CN); Gary M. Robb, Honeoye Falls, NY (US)

(21) Appl. No.: 17/459,440

(22) Filed: Aug. 27, 2021

Related U.S. Application Data
(60) Provisional application No. 63/071,486, filed on Aug. 28, 2020.

(51) Int. Cl. H01M 8/2404; H01M 8/2484; H01M 8/248

(52) U.S. Cl. CPC H01M 8/2404; H01M 8/248; H01M 8/2484

(57) ABSTRACT

A system for assembling a fuel cell stack can include a plurality of fuel cells, a dispenser, and a holder. The dispenser can be configured to successively transfer the fuel cells to the holder. The holder can be configured to successively receive the fuel cells. Each of the fuel cells can be received at a constant position along a first axis. The holder can also be configured to index each received fuel cell by a predetermined distance along the first axis, thereby forming the fuel cell stack. In addition, the holder can compress the fuel cell stack after the fuel cell stack is formed.

### CROSS-REFERENCE TO RELATED APPLICATIONS

This application claims the benefit of U.S. Provisional Application Ser. No. 63/071,486, filed on Aug. 28, 2020. The entire disclosure of the above application is hereby incorporated herein by reference.

### FIELD

The present disclosure relates to fuel cells and, more particularly, to assembling fuel cells.

### INTRODUCTION

This section provides background information related to the present disclosure which is not necessarily prior art.

A fuel cell has been proposed as a clean, efficient, and environmentally responsible power source for various industries, including manufacturing centers, homes, and electric vehicles among other applications. One example of the fuel cell is a proton exchange membrane (PEM) fuel cell. The PEM fuel cell can include a membrane-electrode-assembly (MEA) that can have a thin, solid polymer membrane-electrolyte having an anode and a cathode with a catalyst on opposite faces of the membrane-electrolyte. The MEA can be generally disposed between a pair of porous conductive materials, also known as gas diffusion media, which distribute gaseous reactants, for example, hydrogen and oxygen or air, to the anode and cathode layers. The hydrogen reactant is introduced at the anode where it reacts electrochemically in the presence of the catalyst to produce electrons and protons. The electrons are conducted from the anode to the cathode through an electrical circuit disposed therebetween. Simultaneously, the protons pass through the electrolyte to the cathode where an oxidant, such as oxygen or air, reacts electrochemically in the presence of the electrolyte and catalyst to produce oxygen anions. The oxygen anions react with the protons to form water as a reaction product. The MEA of the PEM fuel cell can be sandwiched between a pair of electrically conductive bipolar plates which serve as current collectors for the anode and cathode layers.

Fuel cell stacks can be used to combine the electrical output of multiple fuel cells, typically configured in series. Multiple fuel cells are combined generally assembled by hand or by partially automated processes to form the fuel cell stack. For example, a number of PEM fuel cells can be layered or stacked to form a continuous column structure, which can be retained, and in some instances further sealed, by a compression retention system applied to the fuel cell stack. These processes can require sequentially aligning each fuel cell as added to the stack (e.g., in an x-y plane), where the sequential addition progresses in a third dimension (e.g., z axis). Poor alignment can lead to a failure of the fuel cell stack. Therefore, each fuel cell should be aligned with high accuracy. Undesirably, this can require extensive labor and production time. In addition, many partially automated processes are not capable of producing fuel cell stacks of varying cell lengths.

There is a continuing need for a system and a method for assembling a fuel cell stack that facilitates aligning a fuel cell during an assembly process. Desirably, the system and the method can reproducibly dispose fuel cells sequentially in forming the fuel cell stack.

### SUMMARY

In concordance with the instant disclosure, a system and a method for assembling a fuel cell stack that facilitates aligning a fuel cell during an assembly process, and which can facilitate aligning each fuel cell in the fuel cell stack, has been surprisingly discovered. This disclosure deals primarily with manufacturing fuel cell stacks. However, it should be appreciated that the automated stack assembly and method of the present disclosure can also be adapted for other products and industries.

In certain embodiments, methods for assembling a fuel cell stack can involve a holder successively receiving a plurality of fuel cells. Each of the fuel cells can be received at a constant position along a first axis. The holder can index each received fuel cell by a predetermined distance along the first axis, thereby forming the fuel cell stack. The fuel cell can then be compressed after the fuel cell stack is formed.

In certain embodiments, systems for assembling a fuel cell stack can include a plurality of fuel cells, a dispenser, and a holder. The dispenser can be configured to successively transfer the fuel cells to the holder. The holder can be configured to successively receive the fuel cells. Each of the fuel cells can be received at a constant position along a first axis. The holder can also be configured to index each received fuel cell by a predetermined distance along the first axis, thereby forming the fuel cell stack. In addition, the holder can compress the fuel cell stack after the fuel cell stack is formed.

In certain embodiments, methods for assembling a fuel cell stack can include successively transferring a plurality of fuel cells to a holder. The holder can successively receive the fuel cells. Each of the fuel cells can be received at a constant position along a first axis. The holder can index each received fuel cell by a predetermined distance along the first axis, thereby forming the fuel cell stack. A blocker can be disposed on a top of the fuel cell stack. The holder can compress the fuel cell stack by pressing the fuel cell stack against the blocker. A retention system can fasten the fuel cell stack after the fuel cell stack has been compressed.

Further areas of applicability will become apparent from the description provided herein. It should be understood that the description and specific examples are intended for purposes of illustration only and are not intended to limit the scope of the present disclosure.

### DRAWINGS

The above, as well as other advantages of the present disclosure, will become readily apparent to those skilled in the art from the following detailed description, particularly when considered in the light of the drawings described herein.

FIG. 1 is an elevational view of a system for assembling a fuel cell stack, according to certain embodiments of the present disclosure, the system including a holder with a plurality of fuel cells and a robotic applicator transferring one of the fuel cells to the holder;

FIG. 2 is another elevational view of the system shown in FIG. 1, wherein the holder has indexed downwardly to allow a received fuel cell to be disposed at a constant position along a first axis;

FIG. 3a is another elevational view of the system shown in FIGS. 1-2, wherein the robotic applicator has transferred the received fuel cell to the fuel cell stack at the constant position along the first axis;

FIG. 3b is yet another elevational view of the system shown in FIGS. 1-3a, wherein the robotic applicator finished transferring the received fuel cell to the fuel cell stack at the constant position along the first axis and is moving away from the fuel cell stack;

FIG. 4a is a top plan view of the system, according to certain embodiments of the present disclosure, the system including a conveyor transferring one of the fuel cells to the fuel cell stack assembled on the holder;

FIG. 4b is an elevational view of the system, according to certain embodiments of the present disclosure, the conveyor transferring fuel cells to the holder, which has been tilted about at least one axis;

FIG. 5 is a further elevational view of the system shown in FIGS. 1-3, according to certain embodiments of the present disclosure, the system including the holder compressing a fuel cell stack against a blocker;

FIG. 6 is a schematic view of the system, according to certain embodiments of the present disclosure, including a fuel cell source, the holder, the dispenser, the blocker, a control unit, a network, and a retention system;

FIG. 7 is a flowchart showing a method for assembling the fuel cell stack, according to certain embodiments of the present disclosure; and

FIG. 8 is a flowchart showing another method for assembling the fuel cell stack, according to certain embodiments of the present disclosure, the method including a step of fastening the fuel cell stack after the fuel cell stack is compressed.

### DETAILED DESCRIPTION

The following description of technology is merely exemplary in nature of the subject matter, manufacture, and use of one or more inventions, and is not intended to limit the scope, application, or uses of any specific invention claimed in this application or in such other applications as can be filed claiming priority to this application, or patents issuing therefrom. Regarding methods disclosed, the order of the steps presented is exemplary in nature, and thus, the order of the steps can be different in various embodiments, including where certain steps can be simultaneously performed.

The terms “a” and “an” as used herein indicate “at least one” of the item is present; a plurality of such items can be present, when possible. Except where otherwise expressly indicated, all numerical quantities in this description are to be understood as modified by the word “about” and all geometric and spatial descriptors are to be understood as modified by the word “substantially” in describing the broadest scope of the technology. The term “about” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that can arise from ordinary methods of measuring or using such parameters.

Although the open-ended term “comprising,” as a synonym of non-restrictive terms such as including, containing, or having, is used herein to describe and claim embodiments of the present technology, embodiments can alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application.

Disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter can define endpoints for a range of values that can be claimed for the parameter. For example, if Parameter X is exemplified herein to have value A and also exemplified to have value Z, it is envisioned that Parameter X can have a range of values from about A to about Z. Similarly, it is envisioned that disclosure of two or more ranges of values for a parameter (whether such ranges are nested, overlapping, or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X can have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it can be directly on, engaged, connected, or coupled to the other element or layer, or intervening elements or layers can be present. In contrast, when an element is referred to as being “directly on,” “directly engaged to,” “directly connected to” or “directly coupled to” another element or layer, there can be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. can be used herein to describe various elements, components, regions, layers and/or sections, these elements, components, regions, layers and/or sections should not be limited by these terms. These terms can be only used to distinguish one element, component, region, layer or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings of the example embodiments.

Spatially relative terms, such as “inner,” “outer,” “beneath,” “below,” “lower,” “above,” “upper,” and the like, can be used herein for ease of description to describe one element or feature's relationship to another element(s) or feature(s) as illustrated in the figures. Spatially relative terms can be intended to encompass different orientations of the device in use or operation in addition to the orientation depicted in the figures. For example, if the device in the figures is turned over, elements described as “below”, or “beneath” other elements or features would then be oriented “above” the other elements or features. Thus, the example term “below” can encompass both an orientation of above and below. The device can be otherwise oriented (rotated 90 degrees or at other orientations) and the spatially relative descriptors used herein interpreted accordingly.

All documents, including patents, patent applications, and scientific literature cited in this detailed description are incorporated herein by reference, unless otherwise expressly indicated. Where any conflict or ambiguity can exist between a document incorporated by reference and this detailed description, the present detailed description controls.

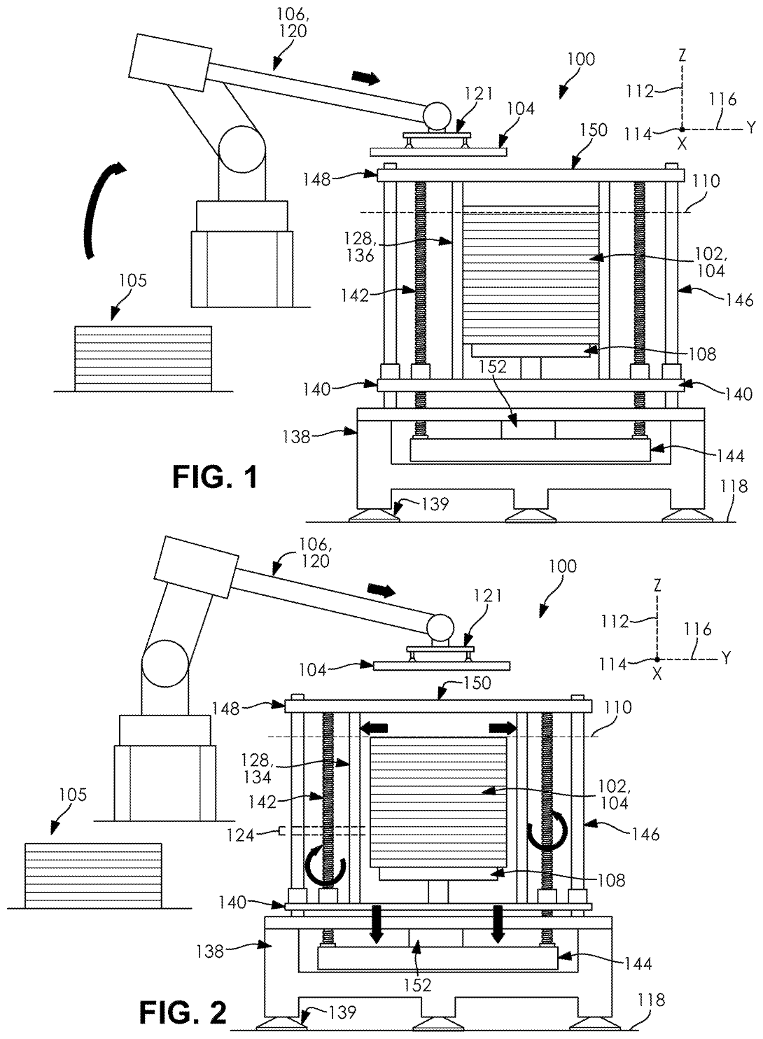

With reference to FIGS. 1-6, a system 100 for assembling a fuel cell stack 102 is shown. The system 100 can have a plurality of fuel cells 104, a dispenser 106, and a holder 108. Each of the fuel cells 104 can include an entirety of the fuel cell 104 and/or miscellaneous fuel cell components, such as bipolar plates. The fuel cells 104 can be supplied from a fuel cell source 105 (shown in FIGS. 1-4 and 6) that can include a manufacturing origin of the individual ones of the fuel cells 104. The dispenser 106 can be configured to successively acquire or provide fuel cells 104 from the fuel cell source 105 for use in the system 100 for assembling the fuel cell stack 102.

In certain examples, each of the fuel cells 104 can include a proton exchange membrane (PEM) fuel cell. The PEM fuel cell can include a membrane-electrode-assembly (MEA) that can have a thin, solid polymer membrane-electrolyte having an anode and a cathode with a catalyst on opposite faces of the membrane-electrolyte. The MEA can be generally disposed between a pair of porous conductive materials, also known as gas diffusion media, which distribute gaseous reactants, for example, hydrogen and oxygen or air, to the anode and cathode layers. The hydrogen reactant is introduced at the anode where it reacts electrochemically in the presence of the catalyst to produce electrons and protons. The electrons are conducted from the anode to the cathode through an electrical circuit disposed therebetween. Simultaneously, the protons pass through the electrolyte to the cathode where an oxidant, such as oxygen or air, reacts electrochemically in the presence of the electrolyte and catalyst to produce oxygen anions. The oxygen anions react with the protons to form water as a reaction product. The MEA of the PEM fuel cell can be sandwiched between a pair of electrically conductive bipolar plates which serve as current collectors for the anode and cathode layers. Other non-limiting examples of the fuel cells 104 can include the fuel cells 104, as described in U.S. Pat. No. 8,586,255 to Robb et al, the entire disclosure which is incorporated by reference. However, it should be appreciated that a skilled artisan can employ different technologies and structures for the fuel cells 104, within the scope of this disclosure.

Now referencing FIGS. 1-4b, the dispenser 106 can be configured to successively transfer the fuel cells 104 (e.g., from the fuel cell source 105 of the fuel cells 104) to the holder 108. The dispenser 106 can transfer each of the fuel cells 104 to the holder 108 at a constant position 110 along a first axis 112, as shown in FIGS. 1-3b.

It should be appreciated that the dispenser 106 has an arm that picks and places the fuel cells 104 on top of the existing stack of cells 102. A non-limiting example of this type of equipment is typically referred to as a “cobot.” The dispenser 106 must be capable of lifting only the top cell 104 from the source 105 without altering the cell 104. The dispenser 106 must then accurately place the cell 104 in the x and y directions then lower it onto the stack of cells 102 in the z direction until it touches the previous top cell 104 (ideally, on the constant position plane 110). The dispenser 106 can also be configured to sense the z location of the topmost cell and adjust accordingly.

It should be further appreciated that the machine or system 100 itself can also be configured to move to ensure the plane 110 is maintained at a fixed point in the z direction.

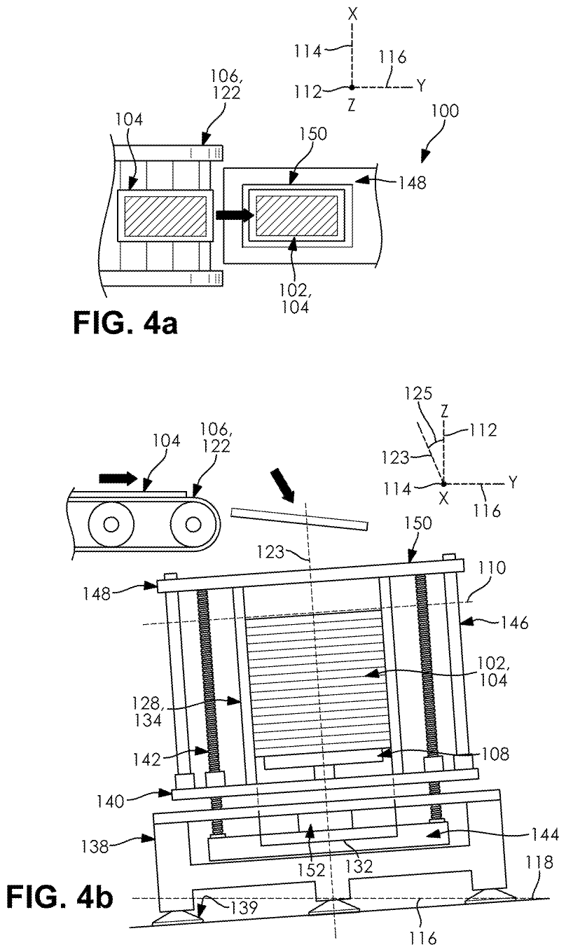

In particular, the holder 108 can be disposed on the first axis 112, a second axis 114, and a third axis 116. The first axis 112 can be orthogonal to the second axis 114 and the third axis 116. It should be appreciated that in FIGS. 1-3b, and 5, the second axis 114 is shown as a dot because the second axis 114 is on the same plane as the plane of view. In addition, in FIG. 4a, the first axis 112 is shown as a dot because the first axis 112 is on the same plane as the plane of view. Also, in FIG. 4b, the third axis 116 is shown as a dot because the third axis 116 is on the same plane as the plane of view. In certain examples, the first axis 112 corresponds to an elevation from a ground surface 118.

The constant position 110 along the first axis 112, being the position to which the dispenser 106 can transfer each of the fuel cells 104 to the holder 108, can be predetermined by the user. Without being bound by any particular theory, it is believed that transferring each of the fuel cells 104 to the holder 108 at the constant position 110 along the first axis 112 can optimize an assembling of the fuel cell stack 102. For instance, if the dispenser 106 is always disposing each of the fuel cells 104 at the substantially same elevation (e.g., the constant position 110 along the first axis 112), it is not necessary for the dispenser 106 to have a new z-coordinate (which corresponds to the first axis 112) for disposing a successive fuel cell 104.

In addition, if the holder 108 remains stationary, when the dispenser 106 transfers each of the fuel cells 104 to the holder 108 to the constant position 110 along the first axis 112, the dispenser 106 can likewise transfer each of the fuel cells 104 at a second constant position along the second axis 114 and a third constant position along the third axis 116. Desirably, this can result in the dispenser 106 no longer having to calculate a new x-coordinate (which corresponds to the second axis 114) and/or a new y-coordinate (which corresponds to the third axis 116) after each of the fuel cells 104 is transferred to the holder 108. Advantageously, this permits for the dispenser 106 to use the same x,y,z coordinates (the constant position 110, the second constant position, and the third constant position) each time the dispenser 106 moves one of the fuel cells 104 from the fuel cell source 105 to the holder 108.

Referring now to FIGS. 1-3b, the dispenser 106 can include a robotic apparatus 120. The robotic apparatus 120 can include a multi-axis robotic arm such as a five- or six-axis robotic arm, as non-limiting examples. The robotic apparatus 120 can also include an end-of-arm tooling or EOT 121. The EOT 121 can be configured to grasp and transfer each of the fuel cells 104 to the holder 108. For example, the robotic apparatus 120 can obtain a fuel cell 104 from the fuel cell source 105 and transfer the fuel cell 104 to the holder 108. Non-limiting examples of the robotic apparatus 120 can include one or more EPSON™ robotic apparatuses sold by Epson America, Inc. and/or FANUC™ robotic apparatuses sold by Fanuc America Corporation.

In other instances, the dispenser 106 can include a conveyor system 122, for example, as shown in FIGS. 4a and 4b. The conveyor system 122 can be configured to transfer each of the fuel cells 104 from the fuel cell source 105 to the holder 108. However, it should be appreciated that a person skilled in the art can employ other technologies for the dispenser 106, within the scope of this disclosure.

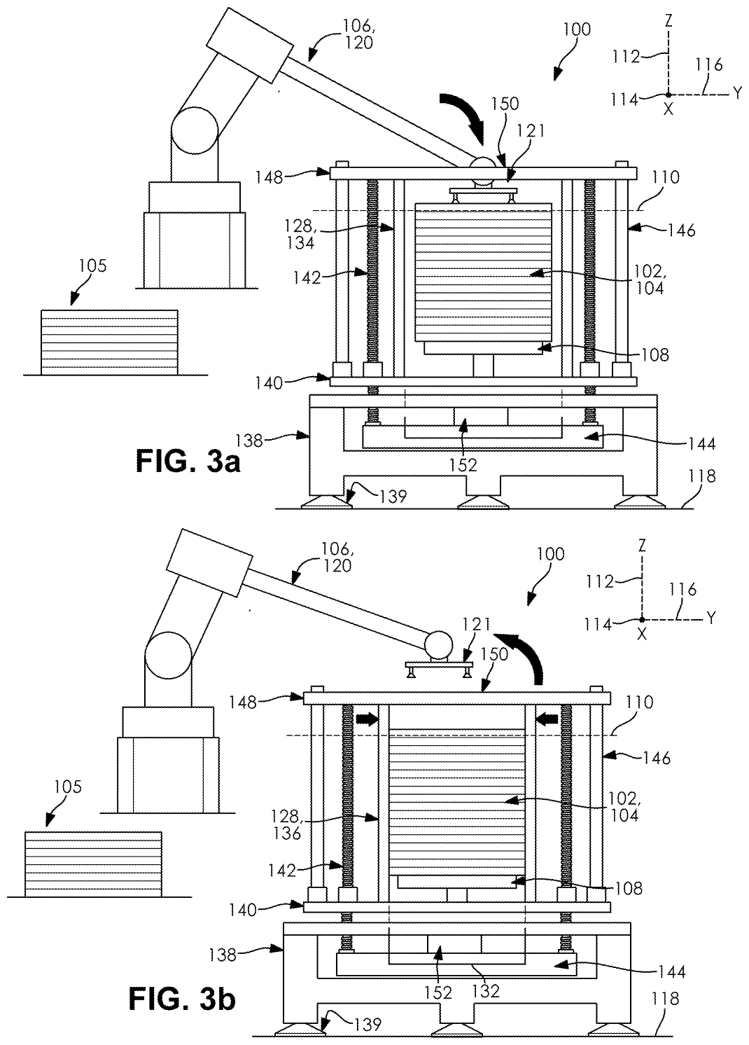

With renewed reference to FIGS. 1-4b, it should be appreciated that the holder 108 can be configured to perform a variety of different functions during the assembly method of the present disclosure. For example, the holder 108 can be configured to successively receive the fuel cells 104, as shown in FIG. 3a. As mentioned previously, each of the fuel cells 104 can be received by the holder 108 at the constant position 110 along the first axis 112. The constant position 110 can be consistently maintained by the holder 108 by an indexing of the received fuel cell 104 (and any other fuel cells 104 present in the growing fuel cell stack 102) along the first axis 112. The step of indexing of the received fuel cell 104 allows for the successive fuel cell 104 to then be also received at the constant position 110. Advantageously, the indexing by the holder 108 can minimize a number of positional calculations that need to be performed by the system 100 in order to correctly position each of the fuel cells 104 within the holder 108.

Now referring to FIG. 4b, the holder 108 can be aligned or tilted along a tilt axis 123 toward the second axis 114 and/or the third axis 116. The holder 108 can include a tilt angle 125. The tilt angle 125 can be relative to the tilt axis 123 and the first axis 112, the second axis 114, and/or the third axis 116. In certain examples, the tilt angle 125 can be relative to the tilt axis 123 and the first axis 112, as shown in FIG. 4b. In certain instances, the tilt angle 125 is less than ninety degrees. In other instances, the tilt angle 125 can be about 80 degrees. Advantageously, such tilting of the holder 108 can allow gravity to facilitate alignment of each of the fuel cells 104 with respect to the second axis 114 and/or third axis 116, as each of the fuel cells 104 is successively received by the holder 108 from the dispenser 106. For example, when one of the fuel cells 104 is received at the constant position 110 along the first axis 112 and the holder 108 is tilted, the received fuel cell 104 can slide via gravity along the second axis 114 and the third axis 116 to be aligned with the other received fuel cells 104. In certain examples, the holder 108 can be tilted by being on a sloped surface, as shown in FIG. 4b. However, it should be appreciated that the system 100 can be modified in other ways to permit the holder 108 to be aligned or tilted along the tilt axis 123. Various guides (not shown) can be used to contact and order the newly disposed fuel cell 104 with respect to the fuel cell stack 102.

Now referencing FIG. 2, the holder 108 can be also configured to index each received one of the fuel cells 104 by a predetermined distance 124 along the first axis 112. In certain examples, the predetermined distance 124 can be substantially equal to a thickness of one of the fuel cells 104. In other examples, the predetermined distance 124 is determined by the user. Desirably, the predetermined distance 124 can allow each subsequently received ones of the fuel cells 104 to be received at the constant position 110 along the first axis 112. In addition, the fuel cell stack 102 can be formed when the holder 108 successively receives the fuel cells 104 and successively indexes each received one of the fuel cells 104 by the predetermined distance 124. In certain examples, the holder 108 can index each one of the fuel cells 104 received by moving the holder 108 downwardly from the constant position 110 along the first axis 112 by the predetermined distance 124. However, it should be appreciated that a skilled artisan can index each of the fuel cells 104 in different directions.

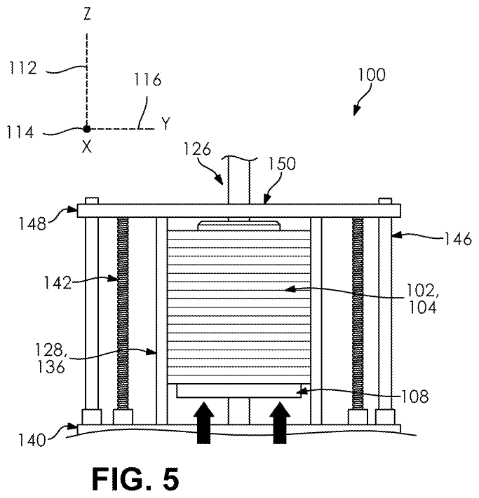

As shown in FIG. 5, the holder 108 can be further configured to compress the fuel cell stack 102 once the fuel cell stack 102 is formed. Desirably, this can militate against one or more of the fuel cells 104 moving out of alignment and/or provide a sealing operation to the resultant fuel cell stack 102. In certain examples, the holder 108 can compress the fuel cell stack 102 by pressing the fuel cell stack 102 against a blocker 126. For instance, the blocker 126 can be disposed on a top of the fuel cell stack 102, then the holder 108 can move upwardly, thereby compressing the fuel cell stack 102 by sandwiching the fuel cell stack 102 between the holder 108 and the blocker 126. Non-limiting examples of the holder 108 can include a hydraulic press ram. The blocker 126 can include a sturdy material capable withstanding the fuel cell stack 102 being compressed against it. In some instances, the blocker 126 can be a separate object, such as a cap. In other instances, the blocker 126 can include the dispenser 106. It should be appreciated that a skilled artisan can employ different technologies for the holder 108 and the blocker 126, as desired. In addition, other methods of compressing the fuel cell stack 102 are contemplated and considered within the scope of this disclosure.

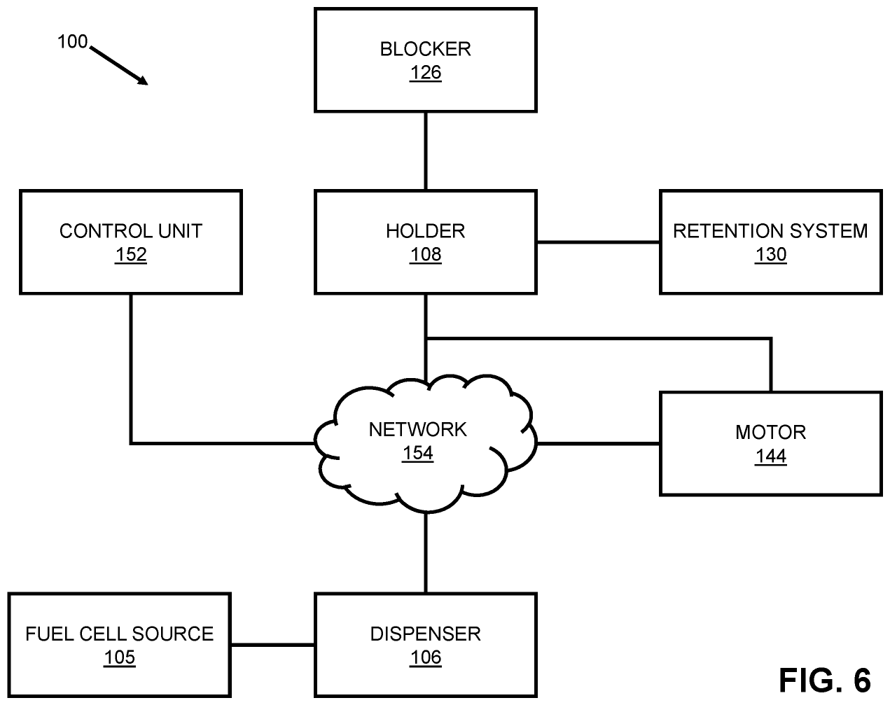

In some embodiments, the system 100 can further include a plurality of retaining bars 128 (shown in FIGS. 1-3b and 5) and a retention system 130 (shown in FIG. 6). The retaining bars 128 can be configured to surround each of the fuel cells 104 stacked on the holder 108. Desirably, the retaining bars 128 assist in keeping the fuel cells 104 aligned in the fuel cell stack 102 after being received by the holder 108. It should be appreciated that one skilled in the art can space each of the retaining bars 128 apart a preselected distance 132 to accommodate fuel cells 104 having different lengths and widths.

In certain examples, each of the retaining bars 128 can be configured to move between an opened position 134 and closed position 136. The retaining bars 128 may also be connected to one or more actuators (not shown), which in turn cause the movement between the opened position 134 and the closed position 136, e.g., as determined by the controller 152 with which the one or more actuators may be in electrical communication. It should be appreciated that moving between the opened position 134 and the closed position 136 can involve moving each of the retaining bars 128 along the first axis 112, second axis 114, and/or the third axis 116. In the opened position 134, each of the retaining bars 128 can be moved away from the fuel cell stack 102, as shown in FIGS. 2 and 3a. Advantageously, the opened position 134 can allow each of the fuel cells 104 to be successively received by the holder 108 without accidently contacting one of the retaining bars 128. With reference to FIGS. 1 and 3b, each of the retaining bars 128 can be moved adjacent to the fuel cell stack 102 and contact the fuel cell stack 102, in the closed position 136. Desirably, the closed position 136 can permit the fuel cell stack 102 to be disposed between each of the retaining bars 128 to align the fuel cell stack 102 along the second axis 114 and/or the third axis 116. In other words, the fuel cell stack 102 can be “sandwiched” between each of the retaining bars 128 to align the fuel cell stack 102 along the second axis 114 and the third axis 116. In the opened position 134, the preselected distance 132 can be greater than the preselected distance 132 in the closed position 136, as shown in FIGS. 3a and 3b. It should be appreciated that a person skilled in the art can employ other methods and technologies for aligning the fuel cell stack 102, as desired.

With reference to FIG. 6, the retention system 130 can be configured to fasten the fuel cell stack 102 after the fuel cell stack 102 has been compressed. The retention system 130 can include screws, rivets, cables, clamps, and/or other fastening technologies. The retention system 130 can provide stability and/or sealing to one or more portions of the fuel cell stack 102. Non-limiting examples can include fastening systems similar to those described in U.S. Pat. No. 7,776,489 to Kum et al., the entire disclosure which is incorporated by reference.

The system 100 can include a base 138, a support plate 140, rotatable threaded rods 142, a motor 144, stability rods 146, and a top plate 148. With reference to FIG. 1, the base 138 can be configured to support the support plate 140 and the holder 108. Desirably, the base 138 can provide stability and structural integrity to the support plate 140 and the holder 108. The base 138 can be disposed below the holder 108 and the support plate 140. In certain examples, the base 138 can include a plurality of legs 139. The legs 139 can be configured to support the base 138 and lift the base 138 off the ground surface 118. It should be appreciated that a skilled artisan can scale the number of the legs 139, within the scope of this disclosure.

Now referring to FIGS. 1-3b and 4b-5, the support plate 140 can be configured to support the holder 108. The support plate 140 can be disposed between the holder 108 and the base 138. The support plate 140 can be configured to move along the first axis 112, the second axis 114, and/or the third axis 116, which can move the holder 108 along the first axis 112, the second axis 114, and/or the third axis 116. For example, the support plate 140 can be configured to move up and down along the first axis 112 to permit the holder 108 to move along the first axis 112. Advantageously, this can permit the support plate 140 to move the holder 108 along the first axis 112. It should be appreciated that other methods can be used to support and/or move the holder 108, within the scope of this disclosure.

As shown in FIGS. 1-3b and 5, the threaded rods 142 can be configured to engage with the support plate 140 to move the support plate 140 about one of the first axis 112, the second axis 114, and/or the third axis 116. Each of the threaded rods 142 can be disposed through the support plate 140 and the base 138, as shown in FIG. 1. In certain examples, each of the threaded rods 142 can be threadably engaged with the support plate 140 to permit the support plate 140 to move along each of the threaded rods 142. Desirably, this can allow the holder 108 to index each of the fuel cells 104 and/or compress the fuel cell stack 102 via the support plate 140 moving along each of the threaded rods 142. It should be appreciated that a skilled artisan can employ other technologies and methods to engage the holder 108 to index each of the fuel cells 104 and/or compress the fuel cell stack 102, within the scope of this disclosure.

With reference to FIGS. 1 and 6, the motor 144 can be configured to engage with the threaded rods 142 to permit the support plate 140 to travel along each of the threaded rods 142. The motor 144 can be attached to the base 138. Non-limiting examples of the motor can include a stepper motor, servo motors, synchronous motors, induction motors, electrostatic motors, etc. It should be appreciated that one skilled in the art can select different driving forces for the motor 144, as desired.

Now referencing FIGS. 1-3b and 4b-5, the stability rods 146 can be configured to provide stability to the support plate 140 as it travels along each of the threaded rods 142. Advantageously, this can militate against the support plate 140 from unintentionally tilting while traveling along each of the threaded rods 142. Each of the stability rods 146 can be disposed through the support plate 140 and the base 138. Desirably, the stability rods 146 can function as a track that militates the support plate 140 from shifting along the second axis 114 and/or the third axis 116.

With reference to FIGS. 1-5, the top plate 148 can be disposed on the threaded rods 142 and the stability rods 146. The top plate 148 can include a fuel cell aperture 150. The fuel cell aperture 150 can be configured to receive each of the fuel cells 102 that is disposed on to the holder 108. Desirably, the fuel cell aperture 150 can allow the dispenser 106 to transfer each of the fuel cells 102 through the top plate 148 and to the holder 108.

While still referring to FIGS. 1 and 6, the system 100 can include a control unit 152. The control unit 152 can include a processor and a memory. The memory can have a tangible, non-transitory computer readable medium with processor-executable instructions stored thereon. The control unit 152 can be in communication with the dispenser 106 and the holder 108. This can be accomplished via a network 154, which can include wireless and/or wired connections. It should be appreciated that the network 154 of the system 100 can include various wireless and wired communication networks, including a radio access network, such as LTE or 5G, a local area network (LAN), a wide area network (WAN) such as the Internet, or wireless LAN (WLAN), as non-limiting examples. It will be appreciated that such network examples are not intended to be limiting, and that the scope of this disclosure includes implementations in which one or more computing platforms of the system 100 can be operatively linked via some other communication coupling, including combinations of wireless and wired communication networks. One or more components and subcomponents of the system 100 can be configured to communicate with the networked environment via wireless or wired connections. In certain embodiments, one or more computing platforms can be configured to communicate directly with each other via wireless or wired connections. Examples of various computing platforms and networked devices include, but are not limited to, smartphones, wearable devices, tablets, laptop computers, desktop computers, Internet of Things (IoT) devices, or other mobile or stationary devices such as standalone servers, networked servers, or an array of servers.

The control unit 152 can in communication with the dispenser 106, the holder 108, and/or the motor 144. The control unit 152 be configured to control and direct the functions of the dispenser 106, holder 108, and the motor 144. Desirably, this can allow the dispenser 106 and the holder 108 to perform operations while remaining in sync. Non-limiting examples of the control unit 152 can include a personal computer, a tablet, a mobile device, a programmable logic controller (PLC), etc. In certain examples, the control unit 152 can be configured to control other processes, such as the blocker 126, the retaining bars 128, and/or the retention system 130. It should be appreciated that a skilled artisan can employ other technologies for the control unit 152, within the scope of this disclosure.

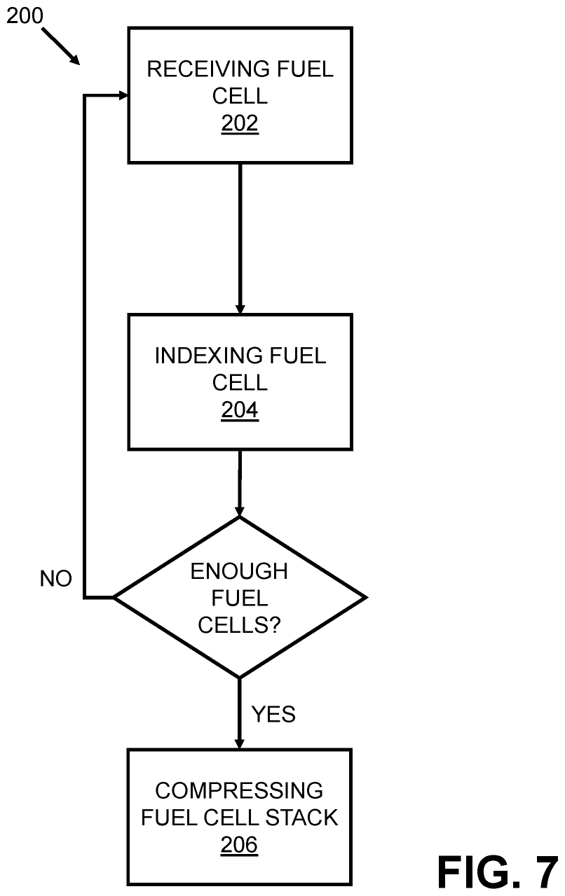

With reference to FIG. 7, an embodiment of a method 200 for assembling the fuel cell stack 102 is shown. The method 200 can have a step 202 of successively receiving the plurality of fuel cells 104 with the holder 108, as shown in FIG. 3a. Each of the fuel cells 104 can be received at the constant position 110 along the first axis 112. As mentioned above, this can permit the fuel cells 104 to be more easily stacked by the dispenser 106 by not requiring the dispenser 106 to calculate a new z-coordinate after each one of the fuel cells 104 is received by the holder 108. In a step 204, and as shown in FIG. 2, the holder 108 can index each received fuel cell 104 by the predetermined distance 124 along the first axis 112, which forms the fuel cell stack 102. Desirably, the predetermined distance 124 permits for each of the fuel cells 104 to be received by the holder 108 at the constant position 110 along the first axis 112. The fuel cell stack 102 can be compressed in a step 206 after the fuel cell stack 102 is formed, as shown in FIG. 5. Advantageously, this can militate against one of the fuel cells 104 from moving out of alignment.

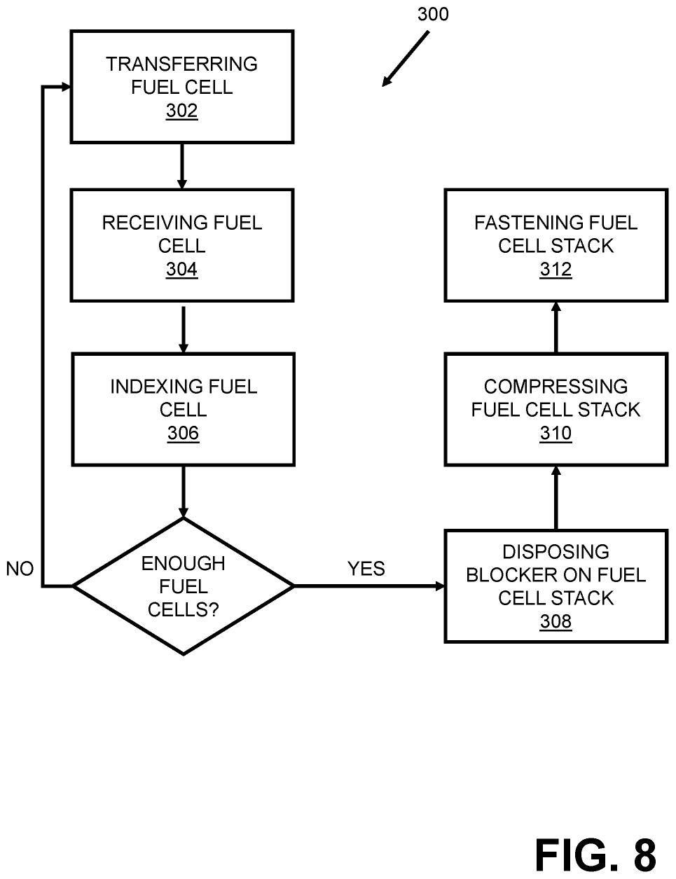

Now referring to FIG. 8, another embodiment of a method 300 for assembling the fuel cell stack 102 is shown. The method 300 can include a step 302 of successively transferring the fuel cells 104 to the holder 108. This can be accomplished via the dispenser 106 (as shown in FIGS. 1-3) and/or manual labor. In a step 304, the holder 108 can successively receive the fuel cells 104, whereby each of the fuel cells 104 is received at the constant position 110 along the first axis 112, like shown in FIG. 3a. With reference to FIGS. 2 and 8, the holder 108 can index each received fuel cell 104 by the predetermined distance 124 along the first axis 112, thereby forming the fuel cell stack 102, in a step 306. In a step 308, the blocker 126 can be disposed on the top of the fuel cell stack 102. The holder 108 can compress the fuel cell stack 102 by pressing the fuel cell stack 102 against the blocker 126, in a step 310 (like shown in FIG. 5). In a step 312, the retention system 130 can fasten the fuel cell stack 102 after the fuel cell stack 102 has been compressed. Desirably, the retention system 130 can maintain the compression of the fuel cell stack 102.

Advantageously, the various systems 100 and methods 200, 300 provided by the present technology can assemble the fuel cell stack 102. In addition, the holder 108 receiving each of the fuel cells 104 at the constant position 110 along the first axis 112 can facilitate a better alignment of the fuel cell stack 102. For instance, the dispenser 106 may not be required to calculate a new z-coordinate after each fuel cell is transferred to the holder 108.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments can be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions, and methods can be made within the scope of the present technology, with substantially similar results.

What is claimed is:

1. A method for assembling a fuel cell stack, comprising:
successively receiving a plurality of fuel cells with a holder, each of the fuel cells being received at a constant position along a first axis;
indexing each received fuel cell by a predetermined distance along the first axis using the holder, thereby forming the fuel cell stack; and
compressing the fuel cell stack.

2. The method of claim 1, wherein the method includes successively transferring the fuel cells to the holder.

3. The method of claim 1, wherein the holder is disposed on the first axis, a second axis, and a third axis, the first axis being orthogonal to the second axis and the third axis.

4. The method of claim 3, wherein the first axis corresponds to an elevation from a ground surface.

5. The method of claim 4, wherein indexing includes by moving the holder downwardly from the constant position along the first axis.

6. The method of claim 4, wherein the holder is tilted toward the second axis and the third axis, thereby allowing gravity to align each of the fuel cells as each of the fuel cells are successively received by the holder.

7. The method of claim 1, wherein the predetermined distance is substantially a thickness of one of the fuel cells.

8. The method of claim 1, wherein the method includes disposing a blocker on a top of the fuel cell stack.

9. The method of claim 8, wherein the fuel cell stack is compressed by pressing the fuel cell stack against the blocker via the holder.

10. The method of claim 1, further including fastening the fuel cell stack with a retention system after the fuel cell stack has been compressed.

11. A system for assembling a fuel cell stack, comprising:
a plurality of fuel cells;
a dispenser configured to successively transfer the fuel cells to a holder; and
the holder configured to:
successively receive the fuel cells, each of the fuel cells being received at a constant position along a first axis;
index each received fuel cell by a predetermined distance along the first axis, thereby forming the fuel cell stack; and
compress the fuel cell stack.

12. The system of claim 11, wherein the dispenser includes a robotic applicator.

13. The system of claim 11, wherein the dispenser includes a conveyor.

14. The system of claim 11, wherein the holder includes a hydraulic press ram.

15. The system of claim 11, further including a retention system configured to fasten the fuel cell stack after the fuel cell stack has been compressed.

16. The system of claim 11, wherein the predetermined distance is substantially a thickness of one of the fuel cells.

17. A method for assembling a fuel cell stack, comprising:
successively transferring a plurality of fuel cells to a holder;
successively receiving the fuel cells with the holder, each of the fuel cells being received at a constant position along a first axis;
indexing each received fuel cell by a predetermined distance along the first axis using the holder, thereby forming the fuel cell stack;
disposing a blocker on a top of the fuel cell stack;
compressing the fuel cell stack by pressing the fuel cell stack against the blocker, via the holder; and
fastening the fuel cell stack with a retention system after the fuel cell stack has been compressed.

18. The method of claim 17, wherein the predetermined distance is substantially a thickness of one of the fuel cells.

19. The method of claim 17, wherein the holder is disposed on the first axis, a second axis, and a third axis, the first axis being orthogonal to the second axis and the third axis.

20. The method of claim 17, wherein the first axis corresponds to an elevation from a ground surface.
